(19) United States
(12) Patent Application Publication
(10) Pub. No.: US 2026/0116275 A1
(43) Pub. Date: Apr. 30, 2026

(54) DEVICE AND METHOD FOR THERMAL CONDITIONING OF A VEHICLE SEAT

(71) Applicant: GENTHERM INCORPORATED, Novi, MI (US)

(72) Inventors: Vikrant Varandani, Novi, MI (US); Ayush Garg, Budapest (HU); Devang Marvania, Auburn Hills, MI (US); Ajay Murgod, Novi, MI (US); Randy Kent Lewis, Greenville, SC (US)

(21) Appl. No.: 19/478,901

(22) PCT Filed: Jul. 17, 2024
(86) PCT No.: PCT/US2024/038342

§ 371 Date: Oct. 27, 2025

Related U.S. Application Data
(60) Provisional application No. 63/528,673, filed on Jul. 25, 2023.

(51) Int. Cl. B60N 2/56; B60N 2/66; B60N 2/90

(52) U.S. Cl. CPC B60N 2/5678; B60N 2/5621; B60N 2/665; B60N 2/914; B60N 2/976

(57) ABSTRACT

A device and method of thermally conditioning a vehicle seat, the method includes activating a thermal conditioning system, the thermal conditioning system having a pushing device, a thermal device configured to generate heating and/or cooling, and a trim or cover layer; compressing the thermal device against the trim or cover layer; the method is configured to increase or decrease a temperature of the trim or cover layer of the vehicle seat.

### CROSS-REFERENCE TO RELATED APPLICATIONS

This application claims priority to U.S. 63/528,673 filed on Jul. 25, 2023, the entirety of which is hereby incorporated by reference herein for all purposes.

### FIELD

These teachings relate to a comfort system for a vehicle seat, and more particularly to a device and method for thermal conditioning of a vehicle seat.

### BACKGROUND

Some vehicle seats include one or more systems for improving occupant comfort. For example, some vehicle seats include one or more thermal systems to heat and/or cool a vehicle seat. While many of these systems are satisfactory for their intended purpose, it may be desirable to improve some of the currently available systems.

For example, it may be desirable to improve vehicle seat heating and/or cooling systems to reduce the time required to heat and/or cool a vehicle seat and/or reduce the energy required to heat and/or cool the vehicle seat. It may be desirable to improve vehicle seat heating and/or cooling systems to reduce the time required to heat and/or cool a vehicle seat before or after an occupant is seated in the vehicle seat. Such improvements may further improve occupant comfort and satisfaction and may be highly desirable for occupants.

### SUMMARY

These teachings provide a comfort system for a vehicle seat. The comfort system according to these teachings may advantageously improve vehicle seat heating and/or cooling efficiencies, which may advantageously reduce the time required to heat and/or cool a vehicle seat and/or reduce the energy required to heat and/or cool the vehicle seat. These teachings provide a device and method to reduce the time required to heat and/or cool a vehicle seat before or after an occupant is seated in the vehicle seat.

When a thermal device according to these teachings or in the state of the art is compressed against the vehicle seat surface by one or more pushing devices according to these teachings, an increase in the rate of heat and/or cooling transfer from the thermal device to the seating surface may occur, which may therefore reduce the time and energy required to achieve a desired seat surface temperature.

The device and method according to these teachings may advantageously substitute occupant weight on the vehicle seat with pressure created by one or more pushing devices in the vehicle seat to compress the thermal device against the seating surface of the vehicle seat to increase the transfer rate of heating or cooling from the thermal device to the seating surface of the vehicle seat. By substituting an occupant weight in the vehicle seat, the seating surface may be pre-conditioned to a desirable temperature before an occupant enters the vehicle and/or is seated in the vehicle seat. This may advantageously improve occupant comfort and satisfaction. This may also be advantageous to maintain a certain temperature of the seat surface after the occupant exits the vehicle but desires the seat surface to be maintained at a certain predetermined temperature.

The device and method according to these teachings may advantageously supplement occupant weight on the vehicle seat with pressure created by one or more pushing devices to further compress the thermal device against the seating surface of the vehicle seat to further increase the transfer rate of heating or cooling from the thermal device to the seating surface of the vehicle seat. By further compressing the thermal device against the seating surface, the rate of heating and/or cooling transfer from the thermal device to the seating surface may be increased which may lead to less time and/or energy required to heat and/or cool the seating surface to a desirable temperature. This may be especially advantageous in situations where an occupant weighs less than a typical occupant.

### BRIEF DESCRIPTION OF THE DRAWINGS

FIG. 1 is a side view of a vehicle that includes a vehicle seat.

FIG. 2 is a cross-sectional view of a vehicle seat.

FIG. 3A is a schematic illustration of the components or layers of the vehicle seat.

FIG. 3B is a schematic illustration of the components or layers of the vehicle seat.

FIG. 4 is a flow diagram illustrating a method of thermal conditioning a vehicle seat.

FIG. 5A is a schematic illustration of the components or layers of the vehicle seat.

FIG. 5B is a schematic illustration of the components or layers of the vehicle seat.

### DETAILED DESCRIPTION

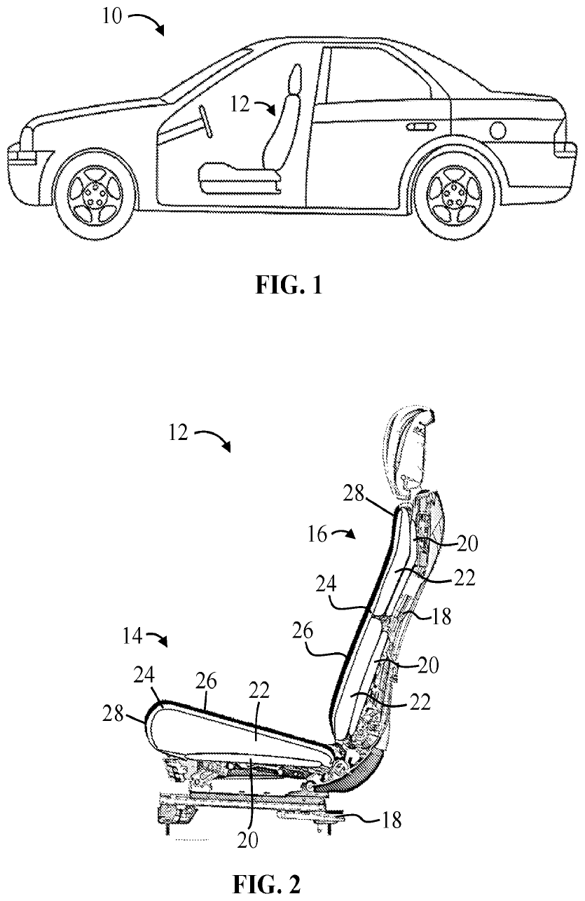

FIG. 1 illustrates a vehicle 10. The vehicle 10 comprises a vehicle seat 12. The vehicle 10 may comprise more than one vehicle seat 12.

FIG. 2 illustrates a vehicle seat 12. The vehicle seat 12 comprises a seating portion 14 and a backrest portion 16.

The seating portion 14 and/or the back rest portion 16 may include a frame or suspension 18 that may be configured to support the seat 12, the seating portion 14, the backrest portion 16, and/or to anchor or attach the seat 12 to the vehicle 10. The vehicle seat 12, seating portion 14, and/or backrest portion 16 may include one or more pushing devices 20, one or more foam pieces 22, one or more thermal devices 24, one or more spacer layers 26, and one or more trim or cover layer 28 surrounding the components of the vehicle seat 12. During use, an occupant may be seated in and in contact with the trim or cover layer 28.

The one or more thermal devices 24 may be configured to generate heating and/or cooling. For example, the thermal device 24 may be, or may include a heating device or mat that generates heat. For example, the thermal device 24 may be, or may include a cooling device or mat that generates coolness. The heating and/or cooling functions generated by the thermal device 24 may be transferred to the trim or cover layer 28 of the seat 12 to cause a temperature of the trim or cover layer 28 to correspondingly increase or decrease. An occupant of the vehicle seat 12 seated or in contact with an A-surface of the trim or cover layer 28, which may be a leather or cloth material for example, may feel the increased or decreased temperature of the layer 28 generated by the thermal device 24.

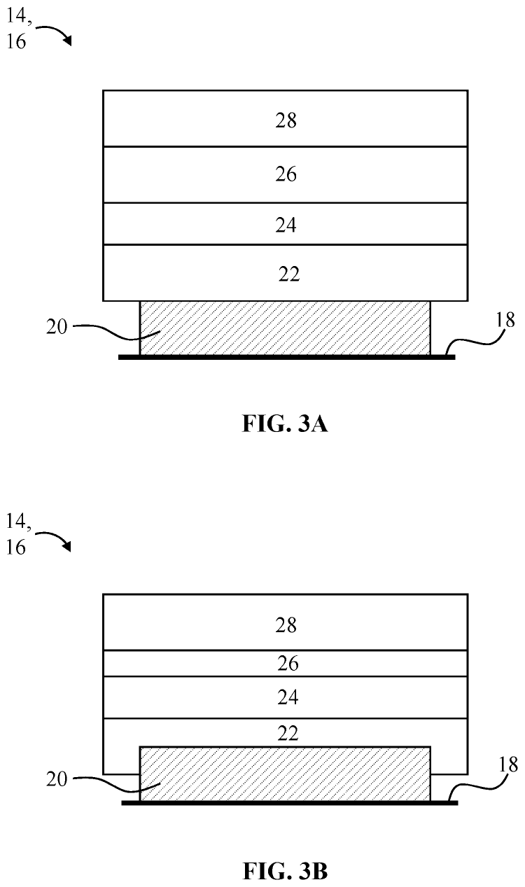

FIGS. 3A and 3B schematically illustrate the seating portion 14 and/or the backrest portion 16 of the vehicle seat. One or both portions 14, 16 may include one or more pushing devices 20, one or more foam pieces 22, one or more thermal devices 24, one or more spacer layers 26, and one or more trim or cover layers 28.

The one or more pushing devices 20 may be supported at, on, or against the frame or suspension 18. The one or more foam pieces 22 may be supported at, on, against, or over the one or more pushing devices 20. The one or more thermal devices 24 may be supported at, on, against, or over the one or more foam pieces 22. The one or more spacer layers 26 may be provided at, on, against, or over the one or more thermal devices 24. The one or more trim or cover layers 28 may be provided at, on, against, or over the one or more spacer layers 26.

Of course, it is understood that one or more of the aforementioned layers or components of the vehicle seat may be eliminated, duplicated, combined, and/or rearranged. A non-limited example of this is the spacer layer 26 may be omitted or combined with the trim or cover layer 28; the one or more pushing devices 20 may be provided at, on, against, or over the one or more foam pieces 22; one or more spacer layers 26 may be added between the one more pushing deices 20 and the one or more foam pieces 22; and so on. In some configurations, a single foam piece 22 and/or a single pushing device 20 may be used for both of the seating and backrest portions 14, 16.

One or more components of the seating and/or back rest portions may be collectively referred to herein as a thermal conditioning system. That is, the thermal conditioning system may comprise one or more or two or more: seating portions, backrest portions, frame or suspensions, pushing devices, foam pieces, thermal devices, spacer layers, trim or cover layers, sensors, controllers, computers, processors, or a combination thereof.

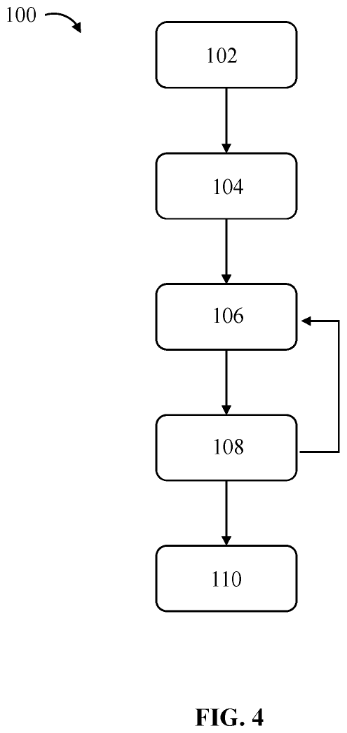

With reference to FIGS. 3A, 3B, and 4, a method 100 for thermally conditioning a vehicle seat 10 is disclosed and may include one or more steps. It is understood that any one or more of the steps disclosed herein may be duplicated, eliminated, rearranged, combined with one or more steps, single steps may be divided or separated into two or more steps, or any combination thereof.

The method 100 may include an activating step 102. The activating step 102 may include activating the thermal device 24. The activating step 102 may include or refer to activating or turning ON the thermal device or mat to begin generating heat or activating or turning ON the cooling device to begin generating cooling.

The activating step 102 may be initiated, activated, or controlled by an occupant located inside or outside of the vehicle; when an occupant is present in the vehicle seat or without an occupant in the vehicle seat; by a person or computer from a remote location; with a remote or key FOB; by an algorithm or program associated with or stored in the computer or memory system of the vehicle, the vehicle seat, at a remote location, in the cloud, or a combination the; according to a preset time/date schedule; or any combination thereof. The activating step 102 may include proving power to the thermal device 24 to begin generating or producing the heating or cooling functions. The power may come from a storage source (i.e., a battery, capacity, solar, engine, motor, etc.)

The method 100 may include a compressing step 104. The compressing step 104 may take place with or without an occupant in the vehicle seat. The compressing step 104 may occur before, during or simultaneously with, or after, the activating step 102.

The compressing step 104 may include the one or more pushing devices 20 compressing, advancing, driving, thrusting, displacing, distorting, deforming, forcing, squeezing, pressing, pushing, or moving, otherwise repositioning one or more layers or components of the vehicle seat 12 or the thermal conditioning system.

The compressing step 104 may cause air to be at least partially removed, evacuated, moved, or squeezed out of or from within one or more layers or components of the vehicle seat or thermal conditioning system. The compressing step 104 may cause or result in a thickness of any of the one or more layers or components of the vehicle seat or thermal conditioning system to be reduced, compressed, or at least partially flattened.

For example, comparing FIG. 3A to FIG. 3B, upon, during, or after the compression step 104 where the pushing device 20 compresses or pushes against the form piece 22, a thickness of the foam piece 22 may be reduced, the spacer layer 26 may be squeezed or compressed between the thermal device 24 and the trim or cover layer 28, thereby causing the spacer layer 26 to be reduced in thickness, and/or one or more layers or components of the vehicle seat to be reduced in thickness or size. The compressing step 104 may cause or result in an increased application of pressure by thermal device 24 against a back side or inside surface of the trim or cover layer 28. During the compressing step 104, an entire width of the one or more layers may be compressed or moved by the pushing device 20. Alternatively, during the compressing step 104, only localized regions of the layers of the thermal conditioning system may be compressed or moved, for example, those areas that may provide more support against an occupant of the seat, for example, the lumbar and bolster regions, headrest, seating part, backrest part, etc.

During the compressing step 104, the pushing device 20 may directly or indirectly push or apply pressure on the thermal device 24. Directly may mean that there are no intermediate layers or components between the pushing device 20 and the thermal device 24. Indirectly may mean that there are one or more intermediate layers or components (i.e., foam 22, layers, panels, plates, etc.) between the pushing device 20 and the thermal device 24.

The compressing step 104 may cause or result in the thermal device 24 being pushed or compressed directly or indirectly against a back side or B-side of the trim or cover layer 28. Directly means that there are no intermediate layers or components between the thermal device 24 and the back side of the trim or cover layer 28 so that the thermal device 24 directly contacts or is directly compressed or pushed against the back of the trim or cover layer 28. Indirectly means that there are one or more intermediate layers or components between the thermal device 24 and the back side of the trim or cover layer 28 (such as spacer layer 26 for example) so that the thermal device 24 indirectly contacts the back of the trim or cover layer 28 (i.e., the one or more intermediate layers or components are also pushed or compressed against the back of the trim or cover layer 28).

As a result of the thermal device 24 being directly or indirectly pressed or compressed against the trim or cover layer 28, the compressing step 104 may advantageously cause or result in an increase in thermal conductively between the thermal device 24 and the trim layer as compared to when the thermal device 24 is not being compressed or pushed against the back of the trim layer 28. The increase in thermal conductively may occur because air, which is an insulator, that is present or located in or between one or more of the components or layers of the vehicle seat between the thermal device 24 and the trim layer 28 is removed or displaced by the compression of the layers via the pushing device. By compressing the one or more layers of the vehicle seat, the air located in and/or between the one or more layers may be removed, evacuated, or reduced. Accordingly, by removing or reducing the amount of insulating air in or between the components of the vehicle seat, the heating and/or colling generated by the thermal device can be passed more easily or even directly to the trim or cover layer. This may advantageously reduce the time required to heat and/or cool a vehicle seat and/or reduce the energy required to heat and/or cool the vehicle seat.

As a result of the thermal device 24 being directly or indirectly pressed or compressed against the trim or cover layer 28, the compressing step 104 may advantageously cause or result in an increase in the rate of temperature change of the trim layer 28 compared to when the thermal device 24 is not being compressed or pushed against the back of the trim layer 28. This may advantageously reduce the time required to heat and/or cool a vehicle seat and/or reduce the energy required to heat and/or cool the vehicle seat.

The method 100 may include a monitoring step 106. The monitoring step 106 may take place with or without an occupant in the vehicle seat. The monitoring step 106 may occur before, during or simultaneously with, or after, the activating step 102 and/or the compressing step 104. The monitoring step 106 may run continuously during the entire method 100 or only during or after one or more of any step disclosed herein. The monitoring step may take place by way of one or more sensors (thermal or temperature), timers, algorithms, look-up tables, processors, computers, or a combination thereof.

The monitoring step 106 may include monitoring, measuring, estimating, and/or determining a temperature of the vehicle seat 12, a temperature of the trim or cover layer 28, a temperature of the inside of the vehicle cabin, or a combination thereof.

The monitoring step 106 may include monitoring, measuring, estimating, and/or determining a temperature change of the vehicle seat 12, a temperature of the trim or cover layer 28, a temperature of the inside of the vehicle cabin, or a combination thereof.

The monitoring step 106 may include monitoring, measuring, estimating, and/or determining an elapsed time that occurs in the activating step 102, the compressing step 104, or both.

The monitoring step may be accomplished using one or more sensors such as one or more temperature sensors, occupancy sensors, timers, or a combination thereof. The one or more sensors may measure, monitor, and/or estimate, a surface temperature of the vehicle seat, of the thermal device, inside the vehicle cabin, outside the vehicle cabin. The monitoring step (and/or the adjusting step) may make use of a lookup table or algorithm to correlate an amount of pushing force required by the one or more pushing deices, elapsed time, amount of heating or cooling generated by the thermal device, or a combination thereof to adjust the parameters of the thermal device and/or the pushing device to most efficiently achieve the desired temperature of the vehicle seat.

The method 100 may include an adjusting step 108. The adjusting step 108 may take place with or without an occupant in the vehicle seat. The adjusting step 108 may take place during and/or after the monitoring step 106 and/or the compressing step 104.

During the adjusting step 108, the thermal device 24 may be adjusted to generate additional or less or the same amount of heating or cooling.

During the adjusting step 108, the pushing device 20 may be adjusted to increase, decrease, or maintain the amount of pushing or compressing forces directed to the one or more layers or components of the vehicle seat 12. For example, the amount of pushing or compressing directed to the one or more layer or components of the vehicle seat 12 may be decreased to cause the amount of thermal conductivity to decrease to thereby reduce the rate of the temperature change of the trim or cover layer 28. Decreasing the rate of the temperature change of the trim or cover layer 28 may be useful when operating in a heating mode to prevent the trim or cover layer 28 from reaching a temperature that is too high and/or to maintain a predetermined temperature. In contrast, decreasing the rate of the temperature change of the trim or cover layer 28 may be useful when operating in a cooling mode to prevent the trim or cover layer 28 from reaching a temperature that is too low and/or to maintain a predetermined temperature. For example, the amount of pushing or compressing directed to the one or more layer or components of the vehicle seat 12 may be increased to cause the amount of thermal conductivity to increase to thereby increase the rate of the temperature change of the trim or cover layer 28 to reduce the amount of time for the surface of the seat to change or be felt by an occupant.

During the adjusting step 108, the pushing device 20 may be modulated, which may cause a repeated or successive increase and decrease in the amount of pushing or compressing directed to the one or more layers. This may help achieve a generally uniform desired temperature at the trim or cover layer or vehicle seat, especially over an extended period.

During the adjusting step 108, the pushing device 20 may increase, decrease, or hold the amount of force, pressure, or compression applied to one or more layers or components of the vehicle seat. In other words, during the adjusting step 108, the pushing device 20 may increase the thermal conductivity between the thermal device 24 and the trim or cover layer 28, decrease the thermal conductivity between the thermal device 24 and the trim or cover layer 28, or hold the thermal conductivity between the thermal device 24 and the trim or cover layer 28. During the adjusting step 108, the pushing device 20 may partially or completely push or compress the layers of the seat.

During the adjusting step 108, the rate of temperature change of the trim or cover layer compared to during the initial compressing step 104 may be increased, decreased, or maintained.

During the adjusting step 108, the amount of heating and/or cooling generated by the thermal device 24 may be adjusted. That is, the amount of heating and/or cooling may be increased, decreased, or held constant.

The adjusting step 108 may also include and/or may be referred to as a compressing step and/or as a subsequent compressing step. This may be especially true if during the adjusting step 108 the force or pressure applied by the pressing device 20 on the thermal device 24 and/or layer or components of the vehicle seat is increased compared to the initial compressing step 104 or if the pressing device 20 is first decreased and then subsequently increased.

The adjusting step 108 may include and/or may be referred to as an uncompressing step and/or as a subsequent uncompressing step. This may be especially true if during the adjusting step 108 the force or pressure applied by the pressing device 20 on the thermal device 24 and/or layer or components of the vehicle seat is decreased compared to the initial compressing step 104 and/or if the force or pressure applied by the pressing device 20 on the thermal device 24 and/or layer or components of the vehicle seat is decreased after a subsequent compressing step.

The adjusting step 108 may also include or be referred to as a hold step where the amount of pressure or compression by the pushing device 20 is maintained and/or the amount of heating and/or cooling by the thermal device 24 is maintained.

The method 100 may include a shutdown step 110. The shutdown step 110 may take place with or without an occupant in the vehicle seat. The shutdown step 110 may take place after any of the steps disclosed herein, such as the monitoring step 106 and/or the adjusting step 108. During or after the shutdown step 110, the thermal device 24 may cease generating heat or cooling. During or after the shutdown step 110, the pushing device 20 may cease generating pressure or pushing or compressing one or more layers or components of the vehicle seat 12. During or after the shutdown step 110, the pushing device 20 may revert to a steady state position. During or after the shutdown step 110, the one or more layers or components of the seat that were previously compressed, displaced, distorted, or moved may revert to a stead state position or configuration.

The shutdown step 110 may include or may be referred to as a pause or standby step where the system or method 100 shuts down for a predetermined amount of time or until another activation event takes place.

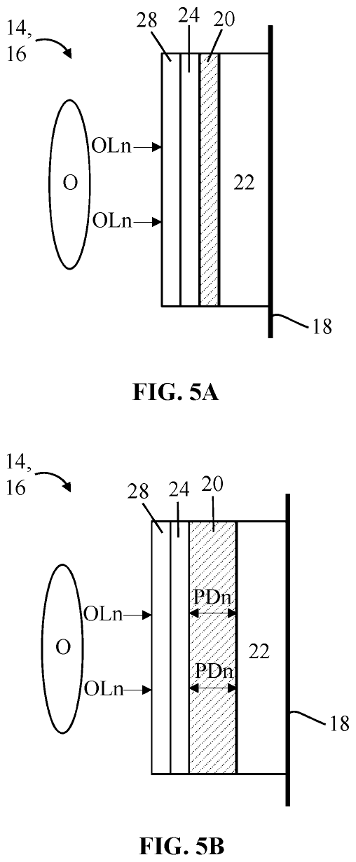

FIGS. 5A and 5B illustrate a schematic of the seating and/or backrest portion 14, 16 of the vehicle seat. The one or more foam pieces 22 may be supported on or over the frame or suspension 18 of the vehicle seat, the one or more pushing devices 20 may be supported on or over the one or more foam piece 22, the one or more thermal devices 24 may be supported on or over the one or more pushing devices 20, and the one or more trim or cover layers 28 may be provided on or over the one or more thermal devices 24. Of course, as was discussed above at FIGS. 3A and 3B, it is understood that one or more of the layers or components of the vehicle seat disclosed herein may be eliminated, duplicated, combined, and/or rearranged. A non-limited example of this is the spacer layer is omitted in this configuration but can be added between or combined with one or more of the layers.

Referring to FIG. 5A, an occupant O is seated in the vehicle seat and supported on the seating and/or backrest portion 14, 16. The pushing device 20 does not generate any applying any pushing or compressive forces. Accordingly, the occupant load OLn of the occupant O is a normal force that is configured to compresses the elements of the seating and/or backrest portions 14, 16 including the foam 22.

Referring to FIG. 5B, an occupant O is seated in the vehicle seat and supported on the seating and/or backrest portion 14, 16. The pushing device 20 is configured to generate and apply an outwardly pushing or compressive force PDn in both directions (i.e., in a direction of the seat foam 22 and in a direction of the thermal device 24). The pushing device is a normal force PDn that therefore resists compression of the foam piece 22 from the occupant load OLn. This may help ensure that the compression occurs between the thermal device 24 and the trim or cover layer 28 so that the thermal transfer occurs between the thermal device and the trim or cover layer 28 as opposed to the occupant load OLn causing the foam 22 to compress, which may reduce the amount of compression or contact between the thermal device 24 and the trim or cover layer.

One or more of the steps in the method 100 disclosed above in FIG. 4 may be used with the configuration in FIGS. 5A-5B. Therefore, in the interest of brevity those steps are not repeated with respect to FIGS. 5A and 5B.

The following description relates to all examples disclosed herein and are not necessarily limited to a specific example unless otherwise noted herein.

Vehicle seat referred to herein may refer to any seat in any vehicle. For example, the vehicle seat may be a front seat, a rear seat, a driver seat, a passenger seat, or a combination thereof. The seat may be a bench seat, a bucket seat, a captain's seat, etc. The vehicle may be an automobile, airplane, train, boat, or bus. The seat may also be used in non-vehicular applications, such as office chairs, wheelchairs, sofas, recliners, and the like. In some configurations, the method and or teachings herein may be incorporated into non-vehicle seat applications. For example, the method and or teachings herein may be incorporated into surfaces and or structures that a person or object may contact or come into close contact with. For example, the device and the method in these teachings herein may be incorporated into vehicle dashboards, vehicle center councils, door panels, footwells, bed mattresses, comforters and blankets, clothing, furniture, or combination thereof.

The pushing device disclosed herein may be a dedicated device that is only configured for compressing and/or increasing a pressure on or between one or more layers or components of the vehicle seat.

The pushing device maybe a device that is part of another device, component, or system of the vehicle seat, and can be also used for compressing and/or increasing a pressure on the one or more layers or components of the vehicle seat according to these teachings. For example, the pushing device may be part of a lumbar system and/or a massage system of the vehicle seat. In such a configuration, the pushing device may include one or more bags, bladders, cells, and or pouches that are configured to be inflated or filled with a fluid to provide the pushing, pressing, and/or compressing functions disclosed herein to push or compress the one or more layers or components of the vehicle seat disclosed herein In contrast, the one/or more bags, bladders, cells, and/or pouches can be deflated to reduce, minimize, or eliminate the pushing, pressing, and/or compressing functions disclosed herein. For example, the one or more bags, bladders, cells, and/or pouches may be of the type disclosed in U.S. Pat. No. 10,906,442 B2, the entire contents of which is hereby incorporated by reference in its entirety for all purposes. The fluid may be air, gas, liquid, or any combination thereof.

In some configurations, the pushing device may be or may include a mechanical or electromechanical device. For example, the pushing device may be or may include one or more piston and cylinder arrangements where a piston is configured to move in and out of a cylinder to apply and remove the pressing and compressing functions disclosed herein from the one or more layers or components of the vehicle seat.

In some configurations, the pushing device may be or may include one or more springs or biasing members that are configured to be uncompressed and compressed to apply and remove the pressing and compressing functions; a blower that is configured to inflate and deflate one or more bags; and other like systems that are configured to expand and contract and that can be incorporated into a vehicle seat structure to accomplish the one or more functional steps and benefits disclosed herein.

A thermal device may be a device or assembly configured to generate heat and/or coldness. The thermal device may be of the type disclosed in U.S. Pat. No. 11,033,058, 6,869,140 B2, the entirety of which is hereby incorporated by reference herein for all purposes.

The thermal device may comprise a heater mat or similar device. The heater mat may incorporate flexible electrical substantially flat heating elements. As examples, the heater mat may be or may include a lay-wire heater, a carbon fiber heater or the like, which are typically supported with a backing (e.g., a cloth or fabric type backing). The heater mat may be a carbon fiber type heater with a backing (e.g., a non-woven layer). The heater mat may be of the type available under the tradename CARBOTEX® and is commercially available from W.E.T. Automotive Systems, Inc. in Germany and/or FTG Fraser-Technik GmbH, Schleizer Strasse 56-58, D-95028 Hot/Saale, Germany. The heater mat may be disclosed in U.S. Pat. Nos. 6,064,037 and/or in 10,201,039 and/or in WO 2018/085104 and/or in WO2018/080659 all of which are expressly incorporated by reference herein for all purposes. The thermal device may be an air conditioner to generate coolness.

A spacer layer may function to reduce read through or visibility of one or more elements or components of the system through an A-surface of the vehicle seat. The spacer layer may function to provide additional padding and or support to an occupant in the vehicle seat. The spacer layer may be sufficiently thick to provide padding and additional comfort to the occupant and reduce read through of any of the comfort functions or the pushing device through an A side of the vehicle seat, however, to not interfere with any massage or lumbar functions of a pneumatic system that may be incorporated into the system. The spacer layer may function to change modify the feel of the seat, increase, or decrease an intensity of the massage or lumbar functions of the pneumatic system that is seen and/or felt by an occupant, or both. The spacer layer may be an air permeable material or layer. The spacer layer may function to facilitate an even distribution of air flow if the vehicle seat is equipped with a ventilated function. The spacer layer may be made of a cloth, fleece, and/or felt material, spun bond material, polyester material, a PET material (polyethylene terephthalate), a foam, a plush foam, or a combination thereof. The spacer layer may be felt or similar, or spacer fabric such as that supplied by Mueller Textile of Germany.

The spacer layer may be configured to collapse, deform, or reduce in size and/or thickness when subjected to compressive and/or other types of forces. The spacer layer may include internal pores or passages that permit air or other fluid to pass therethrough. For example, the spacer layer can comprise an internal lattice or other structure which has internal openings. The spacer layer may be a screen or a mesh. The spacer layer may be compressible, elastic, resilient, or a combination thereof. The spacer layer may be breathable, resistant to crushing, and/or made from a foam, plastic, and/or polymeric material. The spacer layer may include an upper netting layer, a lower netting layer and a plurality of fibers extending between them.

As an example, one preferred material is sold under the tradename 3MESH® and is commercially available from Müller Textil GmbH, Germany or Müller Textiles, Inc.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein may suitably be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may be or may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

### LISTING OF REFERENCE NUMERALS

10 Vehicle
12 Vehicle seat
14 Seating portion
16 Backrest portion
18 Frame or suspension
20 Pushing devices
22 Foam pieces
24 Thermal device
26 Spacer layers
28 Trim or cover layer
100 Method of thermal conditioning of a vehicle seat
102 activating step
104 compressing step
106 monitoring step
108 adjusting step
110 shutdown step

1. A method of thermally conditioning a seat comprising:
i) activating a thermal conditioning system, the thermal conditioning system comprising a pushing device, a thermal device configured to generate heating and/or cooling, and a trim or cover layer;
ii) compressing the thermal device against the trim or cover layer;
wherein the method is configured to increase or decrease a temperature of the trim or cover layer of the vehicle-seat during the compressing step.

2. The method according to claim 1, wherein the activating and/or compressing step takes place without an occupant in the seat.

3. The method according to claim 1, wherein the compressing step comprises increasing a thermal conductivity between the thermal device and the trim or cover layer.

4. The method according to claim 1, wherein the thermal conditioning system comprises a foam piece arranged between the pushing device and the thermal device.

5. The method according to claim 4, wherein the thermal conditioning system comprises a spacer layer arranged between the pushing device and the trim or cover layer.

6. The method according to claim 1, wherein the thermal conditioning system comprises a foam piece arranged between the pushing device and the thermal device and the thermal device is arranged between the pushing device and the trim or cover layer.

7. The method according to claim 1, wherein the pushing device comprises a massage system.

8. The method according to claim 1, wherein the pushing device comprises a lumbar system.

9. The method according to claim 1, wherein the pushing device comprises a blader that is inflated with a fluid during the compressing step.

10. The method according to claim 1, wherein the pushing device comprises a piston and cylinder arrangement that is configured to compress the thermal device against the trim or cover layer.

11. The method according to claim 1, wherein the pushing device comprises a spring or biasing member that is configured to compress the thermal device against the trim or cover layer.

12. The method according to claim 1, wherein the method comprises modulating the pushing device to increase and decrease an amount the thermal device is compressed against the trim or cover layer.

13. The method according to claim 1, wherein the method comprises monitoring the thermal conditioning system.

14. The method according to claim 1, wherein the method comprises adjusting the thermal conditioning system.

15. The method according to claim 1, wherein the method comprises shutting down operation of the thermal conditioning system.

16. The method according to claim 1, wherein the thermal device is a heater.

17. The method according to claim 1, wherein the thermal device is an air conditioning device.

18. A thermal conditioning device for a seat comprising:
a pushing device;
a thermal device; and
a trim or cover layer;
wherein the thermal conditioning device is configured to increase a temperature of the trim or cover layer by moving or compressing the thermal device against the trim or cover layer to increase a thermal conductivity between the thermal device and the trim or cover layer.

19. The thermal conditioning device according to claim 18, wherein the thermal device is a heater or an air conditioning device.

20. The thermal conditioning device according to claim 18, wherein the thermal device is configured to be moved or compressed against the trim or cover layer with or without an occupant in the vehicle-seat, and wherein the pushing device comprises at least one of the following:
i. a mechanical device;
ii. an electromechanical device;
iii. a piston and cylinder arrangement;
iv. a spring or biasing member;
v. a blower configured to inflate one or more bags, bladders, cells, and/or pouches with a fluid.
